(19) United States
(12) Patent Application Publication
(10) Pub. No.: US 2026/0010020 A1
(43) Pub. Date: Jan. 8, 2026

(54) DUAL WAVELENGTH GENERATOR AND TRANSCEIVER

(71) Applicant: Fujitsu Limited, Kawasaki-shi (JP)

(72) Inventors: Yutaro ENOMOTO, Sagamihara (JP); Tatsuya USUKI, Tsukuba (JP); Shinsuke TANAKA, Hiratsuka (JP)

(73) Assignee: Fujitsu Limited, Kawasaki-shi (JP)

(21) Appl. No.: 19/200,852

(22) Filed: May 7, 2025

(30) Foreign Application Priority Data
Jul. 5, 2024 (JP) 2024-109266

(51) Int. Cl. G02F 1/01

(52) U.S. Cl. CPC G02F 1/0121; G02F 1/011; G02F 2201/58

(57) ABSTRACT

A dual wavelength generator includes a first phase modulator to which laser light of a single wavelength is input; a coupling and splitting coupler having first and second inputs and first and second outputs, modulated output of the first phase modulator being connected to the first input and the first output being connected to output of a dual wave device; an optical loop circuit having first and second ends, the second output of the coupling and splitting coupler being connected to the first end; a second phase modulator to which the second end of the optical loop circuit is connected and modulated output of the second phase modulator being connected to the second input of the coupling and splitting coupler; a ring resonator disposed on the optical loop circuit; and controllers respectively controlling a resonance state of the optical loop circuit and a resonance state of the ring resonator.

### CROSS REFERENCE TO RELATED APPLICATIONS

This application is based upon and claims the benefit of priority of the prior Japanese Patent Application No. 2024-109266, filed on Jul. 5, 2024, the entire contents of which are incorporated herein by reference.

### FIELD OF THE INVENTION

Embodiments discussed herein relate to a dual wavelength generator and a transceiver.

### BACKGROUND OF THE INVENTION

To cope with the increasing capacity of optical communications, multi-carrier transceivers are a promising method and multi-wavelength generators needed. From the perspective of size, cost, and electrical power, multi-wavelength generators that generate multiple wavelengths from a single wavelength are demanded. As for a first practical application, currently, there is demand for dual wavelength generators that generate two wavelengths from a single wavelength.

Prior arts related to dual wavelength generators include the following. For example, a coherent transmitter modulator technology that incorporates a laser light source, a Mach-Zehnder modulator, an input coupler, and a loop resonator (for example, refer to X. Chen et al, “Demonstration of a Silicon Ring Resonator Coupling-Modulator-based Coherent Optical Sub-Assembly Operating at 802 Gbps”, Nokia Bell Labs et al, 2023). Further, according to an optical frequency reference generator technology, continuous light from a reference light source is modulated into pulsed light by an optical pulse modulator, input into a circulating ring circuit, and amplified and output by an optical amplifier, whereby pulsed light with multiple resonance peaks is output (for example, refer to Japanese Laid-Open Patent Publication No. H8-262515). Further, a technology for outputting an optical carrier frequency and multiple sidebands thereof includes a frequency comb generator having an interferometer and an optical feedback loop waveguide, the interferometer having multiple optical waveguide arms and the optical feedback loop waveguide having an optical amplifier (for example, refer to Published Japanese-Translation of PCT Application, Publication No. 2014-510948 and U.S. Patent Application Publication No. 2014/0301695). Further, a technology for outputting optical signals of two wavelengths has two light sources, an optical amplifier, an electro-optical modulator such as a Mach-Zehnder interferometer, and a filter such as optical ring resonator (for example, refer to U.S. Patent Application Publication No. 2020/0328573).

### SUMMARY OF THE INVENTION

According to an aspect of an embodiment, a dual wavelength generator for generating light having wavelengths of two types from a single light, the dual wavelength generator includes: a first phase modulator into which laser light of a single wavelength is input; a coupling and splitting coupler having a first input, a second input, a first output, and a second output, modulated output of the first phase modulator being connected to the first input and the first output being connected to an output of a dual wave device; an optical loop circuit having a first end and a second end, the second output of the coupling and splitting coupler being connected to the first end; a second phase modulator to which the second end of the optical loop circuit is connected, modulated output of the second phase modulator being connected to the second input of the coupling and splitting coupler; a ring resonator disposed on the optical loop circuit; and a controller configured to control a resonance state of the optical loop circuit and a resonance state of the ring resonator.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting one example of a dual wavelength generator according to an embodiment.

FIG. 2A is a diagram depicting a circuit structure for dual wavelength generation by a comparison example.

FIG. 2BA is a graph for explaining problems occurring with the comparison example.

FIG. 2BB is a graph for explaining problems occurring with the comparison example.

FIG. 3 is a diagram depicting an example of a hardware configuration of controllers of the dual wavelength generator according to the embodiment.

FIG. 4 is a diagram of an outline of control of the dual wavelength generator according to the embodiment.

FIG. 5 is a flowchart depicting an example of control of the dual wavelength generator according to the embodiment.

FIG. 6A is a graph for explaining suppression of light of unwanted orders by the embodiment.

FIG. 6B is a graph for explaining suppression of light of unwanted orders by the embodiment.

FIG. 7A is a graph for comparing characteristics of the comparison example and the embodiment.

FIG. 7B is a table for comparing characteristics of the comparison example and the embodiment.

FIG. 8 is a graph depicting a relationship between coupling ratio error and IB OSNR for the comparison example and the embodiment.

FIG. 9 is a diagram depicting an example of configuration of a transceiver.

FIG. 10A is a diagram depicting an example of configuration of transmitters.

FIG. 10B is a diagram depicting an example of configuration of Tx modulators.

### DESCRIPTION OF THE INVENTION

First, problems associated with the conventional technologies are discussed. For example, when two wavelengths are generated from a single wavelength of a single light source using the technology of X. Chen et al, manufacturing error of the coupler, which combines and splits the output of multiple modulators, causes light of orders other than the two desired wavelengths to be generated, adversely affecting performance.

Preferred embodiments of the present invention will be explained with reference to the accompanying drawings.

Embodiments of a dual wavelength generator and a transceiver of the present disclosure are described in detail with reference to the accompanying drawings.

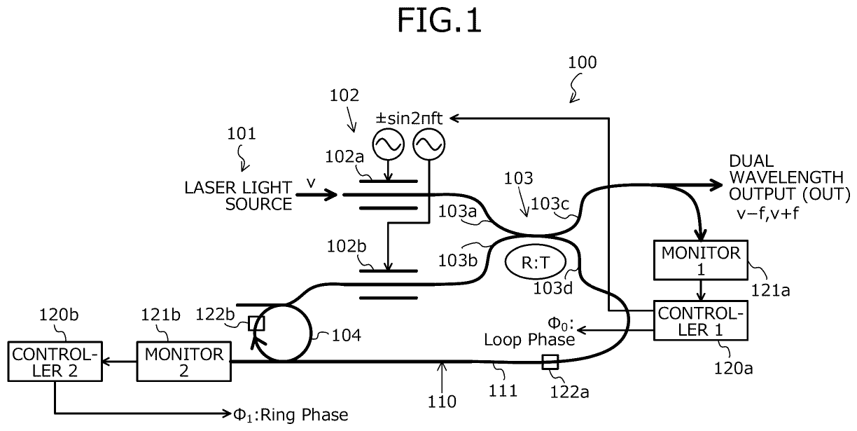

FIG. 1 is a diagram depicting one example of a dual wavelength generator according to an embodiment. A dual wavelength generator 100 generates light having two types of wavelengths from a single light. For example, the dual wavelength generator 100 modulates a light (v) output by a laser light source 101 and thereby generates, from a single light, optical signals (v−f, v+f) of two waves with equally spaced frequencies, and outputs the generated optical signals from an output (OUT). Here, the dual wavelength generator 100 of the embodiment minimizes the amount of unwanted light components such as unmodulated light components and harmonics in the optical signals of the two wavelengths output from the output (OUT).

The dual wavelength generator 100 is applicable to a transceiver that transmits modulated optical signals of two wavelengths. The transceiver transmits modulated light based on a transmission symbol. For example, a dual wavelength transceiver transmits each modulated optical signal at evenly spaced frequencies based on a transmission symbol.

The dual wavelength generator 100 is configured by connecting the following optical circuits to the output of the laser light source 101. The optical circuits include phase modulators 102, a coupling and splitting coupler 103, a ring resonator 104, and an optical waveguide 110 connecting these optical circuits.

The laser light source 101 outputs continuous wave (CW) laser light v (0-th order light) of a single wavelength to a first phase modulator 102a. The phase modulators 102 are constituted by a pair of Mach-Zehnder modulators. The first phase modulator 102a modulates the phase of the input laser light (CW) with a sine wave (+sin 2πft). After an optical signal passes through the ring resonator 104, a second phase modulator 102b modulates the phase of the optical signal with a sine wave (−sin 2πft). The phase modulators 102 (102a, 102b) output multiple optical signals (CW, v−f, v+f, 1st order light) with equal frequency intervals.

The coupling and splitting coupler 103 is a 2×2 coupler with two inputs and two outputs and splits and outputs the optical signal input thereto by a predetermined splitting ratio (for example, reflectance R:transmittance T=50:50). As for the splitting ratio of the coupling and splitting coupler 103, for example, even in an instance of manufacturing in which a predetermined splitting ratio is assumed to be ideal, in actuality, variation error occurs in the splitting ratio due to manufacturing error. In particular, with a 2×2 coupler, manufacturing errors due to the coupler bonding state of the two input and two output couplers, etc. are unavoidable. While described in detail hereinafter, the manufacturing error (variation of the splitting ratio) of the coupling and splitting coupler 103 results in the generation of light of orders other than the two desired wavelengths, whereby various noise standards cannot be satisfied, and performance is adversely affected.

The connection state of the optical circuits by the optical waveguide 110 is described according to the path of the optical signal. The optical signal output by the first phase modulator 102a is input to a first input 103a of the coupling and splitting coupler 103. A first output 103c of the coupling and splitting coupler 103 constitutes the output (OUT) of the dual wavelength (v−f, v+f) optical signal generated by the dual wavelength generator 100.

A second output 103d of the coupling and splitting coupler 103 is connected to the ring resonator 104 via, an optical loop circuit 111 that is a part of the optical waveguide 110. The output of the ring resonator 104 is connected as input to the second phase modulator 102b. The output of the second phase modulator 102b is connected to a second input 103b of the coupling and splitting coupler 103.

In the optical circuits in the embodiment, the phase modulators 102 are respectively disposed on and outside of the path of the optical loop circuit 111. As depicted in FIG. 1, the first phase modulator 102a is disposed outside of the optical loop circuit 111. Further, the second phase modulator 102b is disposed on the optical loop circuit 111. Further, the ring resonator 104 is disposed on the optical loop circuit 111.

Further, the dual wavelength generator 100 includes controllers 120, optical monitors (PDs) 121, and phase shifters 122. The optical monitors 121 include a first monitor (monitor 1 (121a)) and a second monitor (monitor 2 (121b)). The phase shifters 122 include a first phase shifter (phase shifter 1 (122a)) and a second phase shifter (phase shifter 2 (122b)). In the example depicted in FIG. 1, while the controllers 120 are depicted as a first controller (controller 1, 120a) and a second controller (controller 2 (120b)) that are functionally separate, the controller 1 (120a) and the controller 2 (120b) may be a single controller.

A portion of the optical signal of the output (OUT) of the dual wavelength generator 100 is split by a decoupler (not depicted) and the optical power (optical intensity) is detected by the monitor 1 (121a). A portion of the light of the ring resonator 104 does not enter the ring and the optical power thereof is detected by the monitor 2 (121b).

Further, the phase shifter 1 (122a) is disposed on the optical loop circuit 111, at a location free of the ring resonator 104. In the example depicted in FIG. 1, the phase shifter 1 (122a) is disposed on the optical waveguide 110 that connects the ring resonator 104 to the output of the coupling and splitting coupler 103. Without limitation hereto, the phase shifter 1 (122a) may be disposed on the optical waveguide 110 that connects the second phase modulator 102b to the output of the ring resonator 104. Further, the phase shifter 2 (122b) is disposed on the ring portion of the ring resonator 104.

Voltage amplitude applied to the first phase modulator 102a and the second phase modulator 102b is tunable. The monitor 1 (121a) detects an amount corresponding to the optical intensity of the optical signal of the output (OUT) of an unmodulated component, by an optical or electrical method. For example, the monitor 1 (121a) can detect the optical intensities (the optical power) individually for 0-th order light and 1st order light by using a general interferometer that separates the 0-th order light and the 1st order light. For example, a coupling and splitting coupler between one input port and two output ports, a 0-th order optical monitor and a 1st order optical monitor connected to the two output ports, and an asymmetric Mach-Zehnder interferometer capable of electrically adjusting the lengths of two optical paths provided between the input and output ports may be used.

The controller 1 (120a), mainly, controls the resonance state of the optical loop circuit 111. The controller 1 (120a) variably controls the voltage amplitude of a loop phase Φ₀ of the optical loop circuit 111 and the phase modulators 102 (the first phase modulator 102a and the second phase modulator 102b), based on a detection state of the monitor 1 (121a). The loop phase Φ₀ can be varied by the phase of the first phase shifter 122a.

The controller 2 (120b), mainly, controls the resonance state of the ring resonator 104. The controller 2 (120b) variably controls the ring phase of the ring resonator 104, based on a detection state of the monitor 2 (121b). The ring phase Φ₁ can be varied by the phase of the second phase shifter 122b.

While described in detail hereinafter, in the dual wavelength generator 100 of the embodiment, the generation of light of orders other than the two desired wavelengths is suppressed by the connection arrangement of the described optical circuits and the control of the controllers 120, the generation of light of unwanted orders being caused by manufacturing error of the coupling and splitting coupler 103.

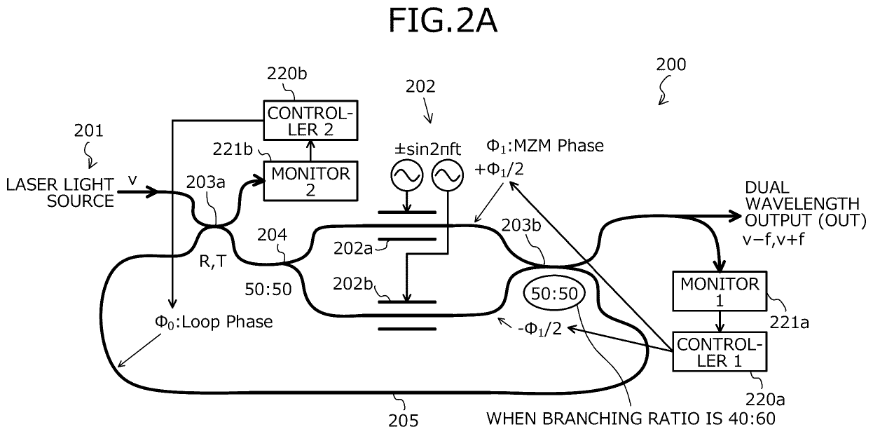

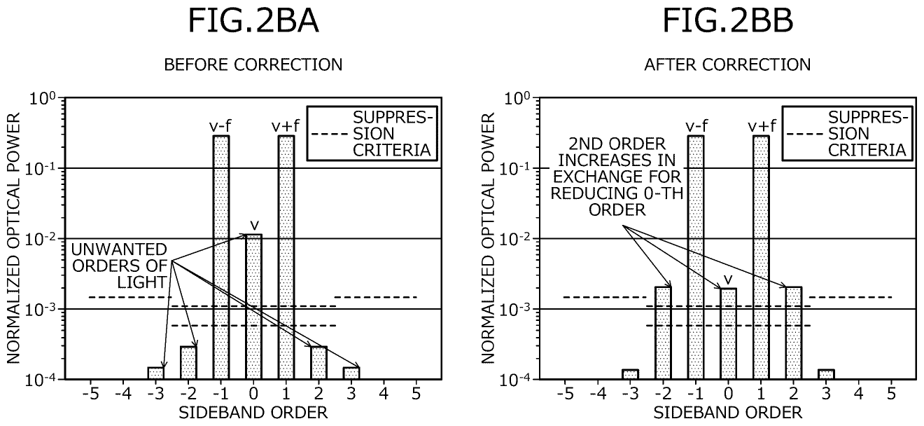

FIG. 2A is a diagram depicting a circuit structure for dual wavelength generation by a comparison example. Here, the comparison example and associated problems are discussed. FIG. 2A corresponds to a modulator circuit 200 of a coherent light subassembly depicted in FIG. 1 of X. Chen et al and additionally shows a controller portion.

The modulator circuit 200 has a laser light source 201, a pair of Mach-Zehnder modulators 202 (202a, 202b), a pair of coupling and splitting couplers 203a, 203b, a decoupler 204, and a loop resonator 205. The laser light source 201 is input to the coupling and splitting coupler 203a and the second output of the coupling and splitting coupler 203a is connected to the respective inputs of the pair of Mach-Zehnder modulators 202a, 202b, via the decoupler 204.

The outputs of the pair of Mach-Zehnder modulators 202 (202a, 202b) are connected to the coupling and splitting coupler 203b. A first output of the coupling and splitting coupler 203b is connected to a dual wavelength output (OUT) and a second output thereof is connected to the coupling and splitting coupler 203a by the loop resonator 205.

The output (OUT) of the modulator circuit 200 is controlled by controllers 220 (220a, 220b). The output (OUT) of the modulator circuit 200 is detected by a monitor 1 (221a) and the controller 1 (220a) controls Mach-Zehnder phases (±Φ₁/2) of the pair of Mach-Zehnder modulators 202 (202a, 202b). A monitor 2 (221b) is connected to the second output of the coupling and splitting coupler 203a and the controller 2 (220b) controls the loop phase Φ₀ of the loop resonator 205.

One aspect in which the modulator circuit 200 of the comparison example depicted in FIG. 2A differs from the dual wavelength generator 100 of the embodiment (FIG. 1) is each of the pair of Mach-Zehnder modulators 202 (202a, 202b) is disposed within the loop resonator 205.

FIGS. 2BA and 2BB are graphs for explaining problems occurring with the comparison example. A horizontal axis indicates frequency in units of sideband (order) and a vertical axis indicates the optical power of the output (OUT). The generation of light of unwanted orders by the circuit structure in FIG. 2A is depicted. When the splitting ratio of the coupling and splitting coupler 203b disposed at the output of the Mach-Zehnder modulators 202 is 40:60 and not the ideal 50:50, the controllers 220 (220a, 220b) perform control for correction.

FIG. 2BA depicts characteristics of the state before correction. In the state before correction, light of orders other than the necessary two wavelengths (v−f, v+f, 1st order light) after modulation is output with a certain optical power from the output (OUT). A state is depicted in which, as light of unwanted orders, 0-th order light (v) at a 0 position, 2nd order light at ±2 positions, and 3rd order light at ±3 positions on the frequency axis are generated. In the state depicted in FIG. 2BA, with respect to the optical level criteria (reference value) for suppression, 0-th order light is of a high optical power that exceeds the suppression criteria, 2nd order light and 3rd order light are of optical powers lower than the suppression criteria.

FIG. 2BB depicts characteristics of the state after correction. A state is depicted in which the controllers 220 (220a, 220b) perform correction control for suppressing light of orders other than the necessary two wavelengths (v−f, v+f). To eliminate (suppress) light of unwanted orders, control for changing the balance of the modulation (amplitude) voltage with respect to the pair of Mach-Zehnder modulators 202 (202a, 202b) is performed.

For example, the 0-th order light (v) having a large optical power depicted in FIG. 2BA exceeds the suppression criteria and control for suppressing the 0-th order light (v) is assumed to be performed. In this instance, as depicted in FIG. 2BB, the optical power of the 2nd order light increases in exchange with a lowering of the optical power of the 0-th order light. As a result, other than the two modulated wavelengths (v−f, v+f) necessary as the output (OUT), the 0-th order light that exceeds the suppression criteria and the 2nd order light are output with a certain optical power. As described, the modulator circuit 200 of the comparison example outputs light of orders other than the desired two wavelengths and thus, performance degrades and predetermined standards cannot be satisfied.

In contrast, in the dual wavelength generator 100 of the embodiment, arrangement configuration of the optical circuits depicted in FIG. 1 and control by the controllers are performed. In the embodiment, as described above, as an arrangement configuration of the optical circuits, the phase modulators 102 (102a, 102b) are respectively provided outside and on the path of the optical loop circuit 111. Further, the ring resonator 104 is disposed on the optical loop circuit 111. Further, the dual wavelength generator 100 of the embodiment corrects manufacturing error of the coupling and splitting coupler 103 by performing control for changing the amplitude of the modulation (voltage) for the phase modulators 102 (102a, 102b) by the controllers 120 (120a, 120b). As a result, in the dual wavelength generator 100 of the embodiment, even when there is manufacturing error of the coupling and splitting coupler 103 (variation of the splitting ratio), light of orders other than the desired two wavelengths is suppressed, and performance satisfying predetermined standards is obtained.

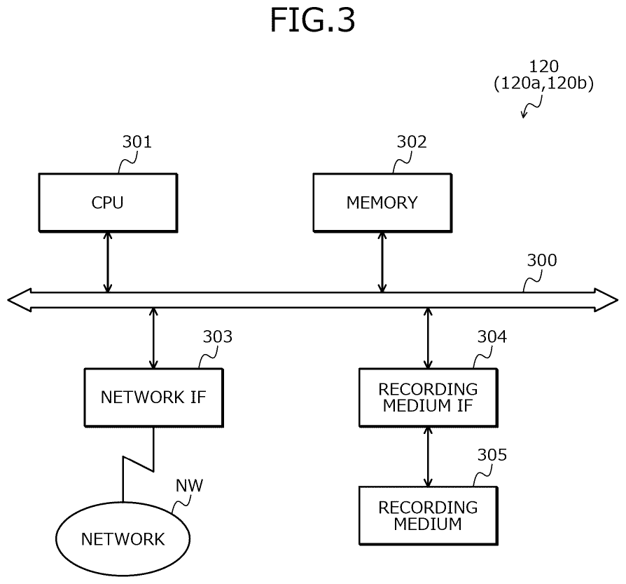

FIG. 3 is a diagram depicting an example of a hardware configuration of the controllers of the dual wavelength generator according to the embodiment. The controllers 120 (120a, 120b) of the dual wavelength generator 100 depicted in FIG. 1, for example, may be configured by the hardware depicted in FIG. 3. Additionally, the controllers 120 may be configured by, for example, an application specific integrated circuit (ASIC) or a field programmable gate array (FPGA).

For example, each of the controllers 120 have a processor 301 such as a central processing unit (CPU), a memory 302, a network IF 303, a recording medium IF 304, and a recording medium 305. Further, the components are connected to each other by a bus 300.

Here, the processor 301 is a controller for governing overall control of the controllers 120. The processor 301 may have multiple cores. The memory 302 includes, for example, a read-only memory (ROM), a random-access memory (RAM), and a flash ROM, etc. More specifically, for example, the flash ROM stores control programs, the ROM stores application programs, and the RAM is used as a work area of the processor 301. Programs stored in the memory 302 are loaded onto the processor 301, whereby encoded processes are executed by the processor 301.

The network IF 303 administers an internal interface with a network NW and controls the input and output of information with respect to external devices.

The recording medium IF 304, under the control of the processor 301, controls the reading and writing of data with respect to the recording medium 305. The recording medium 305 stores therein data written thereto under the control of the recording medium IF 304.

In addition to the components above, the controllers 120 may be connectable to, for example, an input device, a display, etc., via an IF.

Further, in an instance in which the dual wavelength generator is mounted in an optical transceiving device such as a transceiver, the controllers 120 having the hardware configuration depicted in FIG. 3, for example, may be incorporated as one function of a controller.

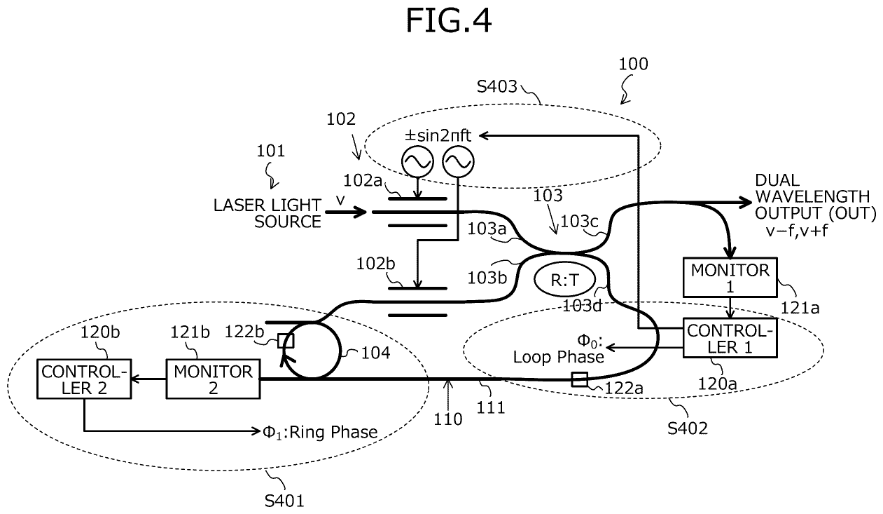

FIG. 4 is a diagram of an outline of control of the dual wavelength generator according to the embodiment. The controllers 120 (120a, 120b) of the dual wavelength generator 100 perform the control shown at steps 1 to 3 below.
1. As for the resonance state of the ring resonator 104, the controller 2 (120b) controls the ring phase Φ₁ so that the optical intensity of the monitor 2 (121b) is minimized (step S401). The ring phase Φ₁ can be controlled by shifting the second phase shifter 122b.
2. As for the resonance state of the optical loop circuit 111, the controller 1 (120a) controls the loop phase Φ₀ so that of the optical intensities detected by the monitor 1 (121a), the optical intensity of an unmodulated component (for example, 0-th order light) is minimized (step S402). The loop phase Φ₀ may be controlled by shifting the phase of the first phase shifter 122a.
3. Further, the optical intensity of unwanted components (light other than 1st order light, such as 0-th order light, 2nd order light) included in the output (OUT) of the dual wavelength generator 100 such as unmodulated components of light and harmonics is minimized as follows. The controller 1 (120a) controls the voltage (amplitude) applied to the first phase modulator 102a and the second phase modulator 102b so that of the optical intensities detected by the monitor 1 (121a), the optical intensity of an unmodulated component is minimized (step S403).

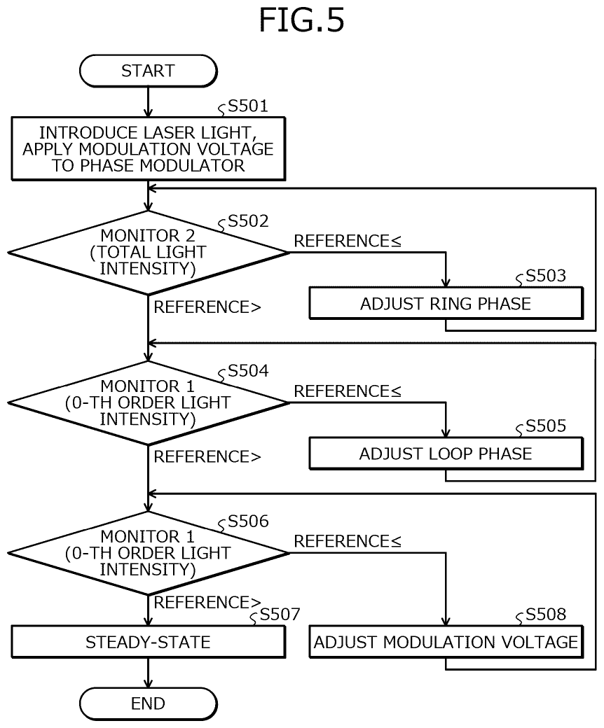

FIG. 5 is a flowchart depicting an example of control of the dual wavelength generator according to the embodiment. For example, the CPU 301 (FIG. 3) having a function of the controllers 120 (120a, 120b) of the dual wavelength generator 100 implements the control.

First, in an initial state such as during device startup, the controllers 120 inject (input) laser light (CW) output by the laser light source 101 and apply modulation voltage to the phase modulators 102 (102a, 102b) (step S501).

Next, the controllers 120 judge the total optical intensity detected by the monitor 2 (121b) (step S502). When the optical intensity detected by the monitor 2 (121b) is at least equal to a predetermined reference (step S502: references), the controllers 120 adjust the ring phase by the second phase shifter 122b (step S503) and return to the control at step S502. At step S503, the ring phase is adjusted so that the total optical intensity detected by the monitor 2 (121b) becomes less than the predetermined reference.

On the other hand, when the optical intensity detected by the monitor 2 (121b) is less than the predetermined reference (step S502: reference>), the controllers 120 transition to the control at step S504.

Next, the controllers 120 judge the optical intensity of the 0-th order light detected by the monitor 1 (121a) (step S504). When the optical intensity of the 0-th order light detected by the monitor 1 (121a) is at least equal to a predetermined reference (step S504: references), the controllers 120 adjust the loop phase by the first phase shifter 122a (step S505) and return to the control at step S504. At step S505, the loop phase is adjusted so that the optical intensity of the 0-th order light detected by the monitor 1 (121a) becomes lower than the predetermined reference.

On the other hand, when the optical intensity of the 0-th order light detected by the monitor 1 (121a) is less than the predetermined reference (step S504: reference>), the controllers 120 transition to the control at step S506.

Next, the controllers 120 judge the optical intensity of the 0-th order light detected by the monitor 1 (121a) (step S506). When the optical intensity of the 0-th order light detected by the monitor 1 (121a) is at least equal to a predetermined reference (step S506: references), the controllers 120 adjusts the modulation voltage of the phase modulators 102 (102a, 102b) (step S508) and return to the control at step S506. On the other hand, when the optical intensity of the 0-th order light detected by the monitor 1 (121a) is less than the predetermined reference (step S506: reference>), the controllers 120 transition to a device steady-state (step S507) and end the control.

During the steady-state at step S507, the controllers 120 may implement the processes at steps S502 to S508 in any sequence. For example, during the steady-state, the controllers 120 can execute the processes in the sequence in which the judgment reference at steps S502, S504, S506 are exceeded or may execute the processes for the judgement reference in parallel. In this case, by setting stricter values (threshold values) for the optical intensity, which is the judgment reference for steps S502, S504, and S506, it is possible to minimize each optical intensity after control based on each of the judgment reference.

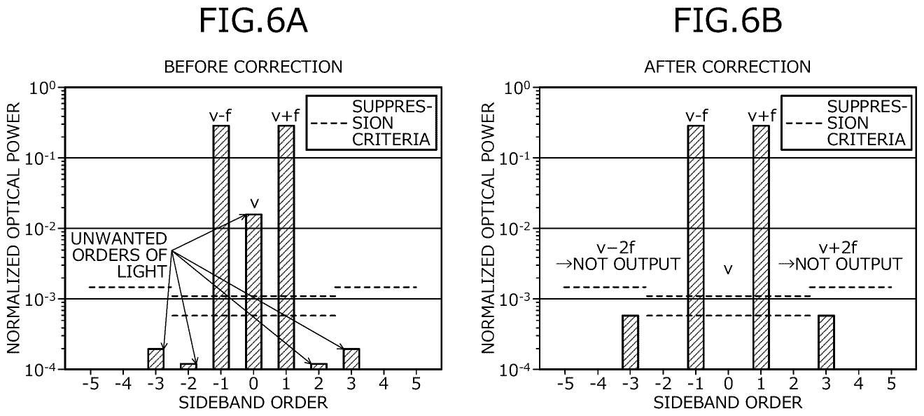

FIGS. 6A and 6B are graphs for explaining suppression of light of unwanted orders by the embodiment. A horizontal axis indicates frequency in units of sideband (order) and a vertical axis indicates the optical power of the output (OUT). Here, as depicted, while the splitting ratio of the coupling and splitting coupler 103 disposed at the output of the phase modulators 102 is ideally 58:42, there are instances when the splitting ratio is 48:52.

FIG. 6A depicts characteristics of the state before correction. In the state before correction, in the comparison example (similar to FIG. 2BA), light (0-th order light, 2nd order light, 3rd order light) of orders other than the two necessary modulated wavelengths (v−f, v+f, 1st order light) is output with a certain optical power from the output (OUT). In the state depicted in FIG. 6A, with respect to the optical level suppression criteria, 0-th order light is of a high optical power that exceeds the suppression criteria, 2nd order light and 3rd order light are of optical powers lower than the suppression criteria.

FIG. 6B depicts characteristics of the state after correction. A state is depicted in which the controllers 120 (120a, 120b) perform correction control for suppressing light of orders other than the necessary two wavelengths (v−f, v+f).

In this case, as depicted in FIG. 5, the controller 2 (120b) performs phase control of the ring resonator 104. Further, to perform phase control of the optical loop circuit 111 and remove (suppress) light of unwanted orders, the controller 1 (120a) performs control to increase the modulation (amplitude) voltage for the phase modulators 102 (102a, 102b) in phase by 25%.

As a result, as depicted in FIG. 6B, the 0-th order light (v), which has large optical power, is below the suppression criteria and removed. Concurrently, the optical power of the 2nd order light (v−2f,v+2f) is also below the suppression criteria and removed. Further, while the optical power of the 3rd order light increased as compared to before correction, the optical power of the 3rd order light is suppressed to be not more than the suppression criteria.

As described, the dual wavelength generator 100 of the embodiment may suppress the output of light of orders other than the desired two wavelengths of light. According to the embodiment, for example, even when the splitting ratio of the coupling and splitting coupler 103 deviates 10%, correction is possible by performing control to increase the modulation (amplitude) voltage for the phase modulators 102 (102a, 102b) in phase by 25%.

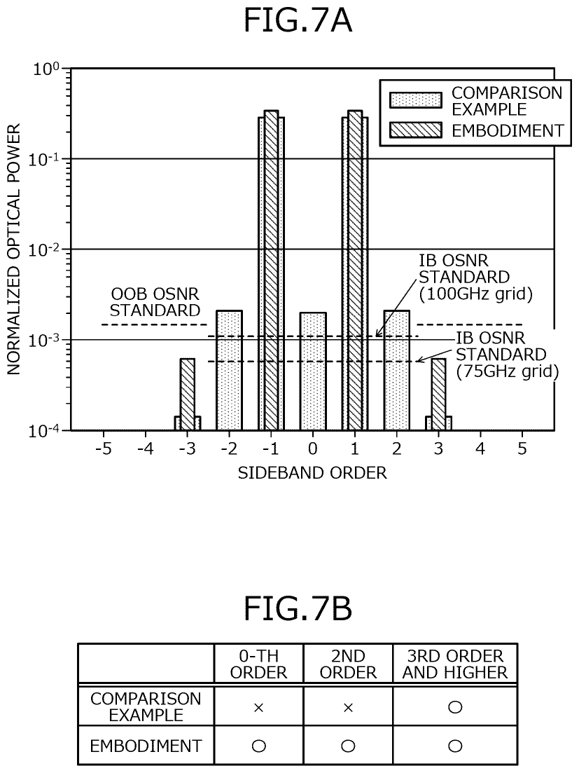

FIG. 7A is a graph and FIG. 7B is a table for comparing characteristics of the comparison example and the embodiment. In FIG. 7A, a horizontal axis indicates frequency in units of sideband (order) and a vertical axis indicates the optical power of the output (OUT). Characteristics of the comparison example after correction (FIG. 2BB) and characteristics of the embodiment after correction (FIG. 6B) are depicted. Further, along a vertical axis, an in-band (IB) OSNR standard (100 GHz grid and 75 GHz grid) and an out-of-band (OOB) OSNR standard are indicated. The IB OSNR standard limits the optical intensities of 0-th order light and 2nd order light while the OOB OSNR standard limits the optical intensity of 3rd order light and higher.

As depicted in a comparison table in FIG. 7B, in the comparison example, while the output of 3rd order light and higher is suppressed and the OOB OSNR standard is satisfied, output of 0-th order light and 2nd order light cannot be suppressed and the IB OSNR standard is not satisfied. In contrast, according to the embodiment, the output of 0-th order light and 2nd order light is suppressed and the IB OSNR standard is satisfied. Further, the output of the 3rd order light and higher is suppressed and the OOB OSNR standard is satisfied.

In the comparison example (FIG. 2A), even though the modulation voltage for the Mach-Zehnder modulators 202 (202a, 202b) is corrected, the standards cannot be satisfied. For example, even with control by the modulation voltage, a splitting ratio R of the coupling and splitting coupler 203b can only be varied within a range of 45.5%<R<54.5% (allowable range 9%).

In contrast, according to the embodiment (FIG. 1), the modulation voltage can be varied within a range of ±3 dB for the phase modulators 102 (102a, 102b), whereby a splitting ratio R of the coupling and splitting coupler 103 can be corrected within a range of 39.0%<R<70.5% (allowable range 31.5%).

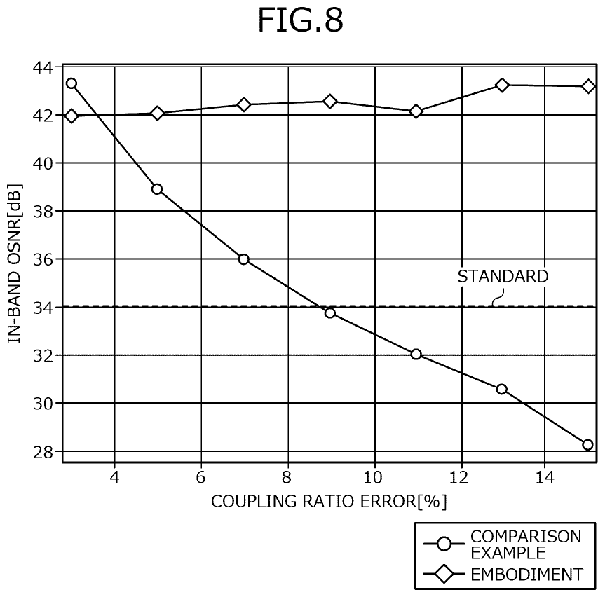

FIG. 8 is a graph depicting a relationship between coupling ratio error and IB OSNR for the comparison example and the embodiment. In a 75 GHz grid and a 64 GBd, a horizontal axis indicates the coupling ratio error of the coupling and splitting coupler and a vertical axis indicates IB OSNR. In the comparison example, IB OSNR degrades as the coupling ratio error increases and the standard cannot be satisfied. In contrast, in the embodiment, the standard can be satisfied over an entire range of the coupling ratio error. According to the embodiment, even when the coupling ratio error exceeds 5%, OSNR can be improved by 3 dB or more.

The reference values for the above characteristics are the required extinction ratios (typical values: C or L band) of the modulator in the standardization of coherent driver module (CDM): Parent: 22 dB, Child: 25 dB. This is converted into the coupling ratio error of the coupling and splitting coupler on the output side and assumed to be |R−T|˜16%, 11%. Further, in the comparison example, the typical value of CDM is outside the allowable range.

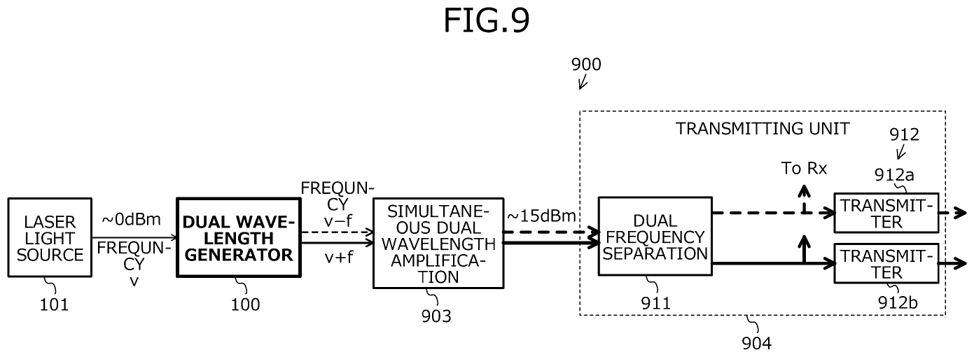

An application example of the embodiment is described. FIG. 9 is a diagram depicting an example of configuration of a transceiver. The dual wavelength generator 100 described above is applicable to a dual wavelength transceiver. In the example of configuration of a transceiver 900 depicted in FIG. 9, laser light of a frequency v (˜0 dBm) output by the laser light source 101 is input to the dual wavelength generator 100 of the embodiment (refer to FIG. 1).

The laser light source 101 may be a tunable laser. The dual wavelength generator 100 generates light of two wavelengths (v−f, v+f) of frequencies equally spaced from the laser light v and outputs the light to an erbium-doped fiber amplifier (EDFA) 903 constituting an optical amplifier. The EDFA 903 optically amplifies the light of the two wavelengths (v−f, v+f) collectively and outputs the amplified light to a transmitting unit 904.

The transmitting unit 904 separates the input light of the two wavelengths (v−f, v+f) according to wavelength using an asymmetric Mach-Zehnder interferometer (AMZI) 911. The light of one of the two wavelengths and the light of the other of the two wavelengths separated by the AMZI 911 are output to transmitters 912 (912a, 912b), respectively. The light of the two wavelengths separated by the AMZI 911 is further output to a Rx receiving unit (not depicted) on a receiving side.

Transmitter modulators 912 (912a, 912b) optically modulate each electrical signal for transmission input thereto and output optical signals of two wavelengths.

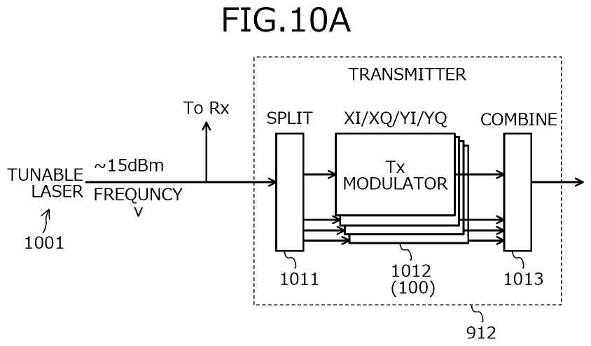

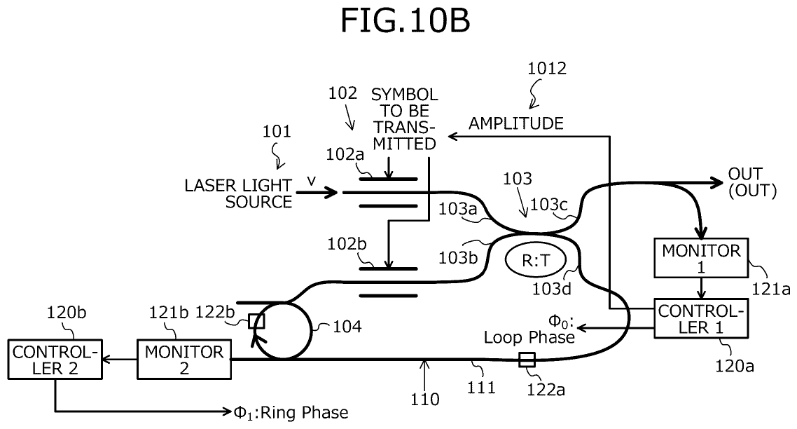

FIG. 10A is a diagram depicting an example of configuration of the transmitters. The transmitters 912 each include a splitter 1011, a resonant Tx modulator 1012, and a multiplexer 1013. In the example of configuration depicted in FIG. 10A, the transmitters 912 perform both X and Y polarization and quadrature amplitude modulation (QAM). In this instance, the splitter 1011 splits the laser light into four pairs XI, XQ, YI, YQ (multiplexing count) and outputs the light to each of four Tx modulators 1012. The multiplexer 1013 multiplexes and outputs optically modulated multiplexed signals. The transmitters 912 can also be configured with a peripheral interface controller (PIC).

FIG. 10B is a diagram depicting an example of configuration of the Tx modulators. The Tx modulators 1012 depicted in FIG. 10A have the same basic configuration, such as the layout, as the dual-wavelength generator 100 (FIG. 1) described above, and components that are the same are given the same reference numerals used in FIG. 1. In the phase modulators 102 described in FIG. 1, while sine wave control input is assumed, in the Tx modulators 1012 depicted in FIG. 10B, instead of sine waves, modulation is performed based on a symbol (electrical signal) to be transmitted. With respect to the phase modulators 102, the controller 1 (120a) controls the amplitude of the symbol to be transmitted. The Tx modulators 1012 are not limited to a dual wavelength transceiver and may be disposed in a single wavelength transceiver or a multiwavelength transceiver.

According to the Tx modulators 1012, for example, the resonant structure allows for a small modulation voltage amplitude, whereby lower power consumption can be expected. Further, control of the extinction ratio is possible and satisfaction of the necessary extinction ratio of the modulators can be expected.

The dual wavelength generator of the embodiment described above generates light of two wavelength types from a single light and includes: a first phase modulator to which laser light of a single wavelength is input; a coupling and splitting coupler having first and second inputs and first and second outputs, modulated output of the first phase modulator being connected to the first input thereof and the first output being connected to an output of a dual wave device; an optical loop circuit having first and second ends, the second output of the coupling and splitting coupler being connected to the first end; a second phase modulator to which the second end of the optical loop circuit is connected, modulated output of the phase modulator being connected to the second input of the coupling and splitting coupler; a ring resonator disposed on the optical loop circuit; and a controller for controlling a resonance state of the optical loop circuit and a resonance state of the ring resonator. As a result, two wavelengths can be generated from a single wavelength and even when the coupling and splitting coupler has manufacturing error, the generation of light of unwanted orders can be easily suppressed.

Further, the dual wavelength generator of the embodiment may include a first phase shifter disposed on the optical loop circuit, the first phase shifter adjusting a ring phase of the optical loop circuit and a second phase shifter disposed on the ring resonator, the second phase shifter adjusting a ring phase of the ring resonator; the controller may control a modulation voltage amplitude for the first phase modulator and the second phase modulator and may control a phase shift amount for the first phase shifter and the second phase shifter. As described, phases of the optical loop circuit and the ring resonator and the voltage amplitudes of the first and second phase modulators are controlled, whereby the generation of light of unwanted orders can be easily suppressed.

Further, the dual wavelength generator of the embodiment may include a first monitor that monitors output light of the device and a second monitor that monitors light that is on the optical loop circuit but not input to the ring resonator; the controller may compare a total optical intensity monitored by the second monitor and a predetermined reference value, control the second phase shifter so that the total optical intensity is less than the reference value, compare the optical intensity of light of an unmodulated component monitored by the first monitor and a predetermined reference value, control the first phase shifter so that the optical intensity of the light of the unmodulated component is less than the reference value, compare the optical intensity of the light of the unmodulated component monitored by the first monitor and a predetermined reference value, and control the modulation voltage amplitude applied to the first phase modulator and the second phase modulator so that the optical intensity of the light of the unmodulated component is less than the reference. As a result, the optical intensity of the optical loop circuit and the optical intensity of the ring resonator are each monitored and based on the monitored optical intensities, the phases of the optical loop circuit and the ring resonator, and the voltage amplitudes of the first and second phase modulators are controlled, whereby the generation of light of unwanted orders can be easily suppressed.

Further, in the dual wavelength generator of the embodiment, the first monitor may detect light of an unmodulated component and light of a modulated component, by an optical or an electrical method. As described, optical intensities of the light of an unmodulated component and the light of a modulated component are separated and detected, whereby optimal control based on the optical intensities of the light of an unmodulated component and the light of a modulated component can be performed.

For example, the first monitor has an interferometer for separating and individually detecting unmodulated 0-th order light and modulated 1st order light. As a result, controller may compare the total optical intensity monitored by second monitor with a predetermined reference value, control the second phase shifter so that the total optical intensity is less than the reference, compare optical intensity of the 0-th order light monitored by the first monitor with a predetermined reference value, control the first phase shifter so that the optical intensity of the 0-th order light is less than the reference, compare the optical intensity of the 0-th order light monitored by the first monitor and a predetermined reference value, and control the modulation voltage amplitudes applied to the first phase modulator and the second phase modulator so that the optical intensity of the 0-th order light is less than the reference. As described, the 0-th order light and the 1st order light are separated and detected, whereby optimal control based on the 0-th order light component, and the total optical intensity can be performed.

Further, the transceiver of the embodiment may have a laser light source that outputs laser light of a single wavelength, the described dual wavelength generator, an optical amplifier, and a transmitting unit. The optical amplifier optically amplifies the light of two wavelengths output by the dual wavelength generator; and the transmitting unit includes two transmitters that each modulate a transmission symbol. As described, a dual wavelength transceiver can be obtained that uses the dual wavelength generator that generates two wavelengths from a single wavelength; the dual wavelength transceiver uses light having wavelengths of the two types, for example, light of frequencies equally spaced from a single light and transmits an optical signal modulated based on a transmission symbol; and the dual wavelength transceiver optically modulates the two wavelengths of light in which the generation of light of unwanted orders is suppressed, inserts the symbol, and outputs the resulting light, whereby various noise standards can be satisfied and performance can be improved.

Further, the Tx modulator in the transmitter may have a same configuration as that of the dual wavelength generator described above and is of a quantity corresponding to a multiplexing count of the optical signal. As a result, the resonant structure of the Tx modulator allows for a small modulation voltage amplitude, whereby reduced power consumption and extinction ratio control are possible, and performance of the transmitter can be improved.

According to one aspect of the present invention, an effect is achieved in that two wavelengths are generated from a single wavelength and the generation of light of unwanted orders can be suppressed easily.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A dual wavelength generator for generating light having wavelengths of two types from a single light, the dual wavelength generator comprising:
a first phase modulator into which laser light of a single wavelength is input;
a coupling and splitting coupler having a first input, a second input, a first output, and a second output, modulated output of the first phase modulator being connected to the first input and the first output being connected to an output of a dual wave device;
an optical loop circuit having a first end and a second end, the second output of the coupling and splitting coupler being connected to the first end;
a second phase modulator to which the second end of the optical loop circuit is connected, modulated output of the second phase modulator being connected to the second input of the coupling and splitting coupler;
a ring resonator disposed on the optical loop circuit; and
a controller configured to control a resonance state of the optical loop circuit and a resonance state of the ring resonator.

2. The dual wavelength generator according to claim 1, further comprising:
a first phase shifter disposed on the optical loop circuit, the first phase shifter adjusting a ring phase of the optical loop circuit; and
a second phase shifter disposed on the ring resonator, the second phase shifter adjusting a ring phase of the ring resonator, wherein
the controller controls a modulation voltage amplitude for the first phase modulator and the second phase modulator and controls a phase shift amount of the first phase shifter and the second phase shifter.

3. The dual wavelength generator according to claim 2, further comprising:
a first monitor monitoring the light output from the dual wave device; and
a second monitor monitoring light that is on the optical loop circuit but not input to the ring resonator, wherein
the controller:
compares a total optical intensity monitored by second monitor and a predetermined reference value, and controls the second phase shifter so that the total optical intensity is less than the reference value,
compares a predetermined reference value and an optical intensity of an unmodulated component of the light monitored by the first monitor and controls the first phase shifter so that an optical intensity of the unmodulated component of the light is less than the reference value, and
compares a predetermined reference value and the optical intensity of the unmodulated component of the light monitored by the first monitor and controls a modulation voltage amplitude applied to the first phase modulator and the second phase modulator so that the optical intensity of the unmodulated component of the light is less than the reference value.

4. The dual wavelength generator, according to claim 3, wherein the first monitor detects light of the unmodulated component and light of a modulated component by an optical or an electrical method.

5. The dual wavelength generator according to claim 3, wherein
the first monitor has an interferometer that separates and individually detects unmodulated 0-th order light and modulated 1st order light, and
the controller
compares the total optical intensity monitored by the second monitor and the predetermined reference value and controls the second phase shifter so that the total optical intensity is less than the reference value,
compares an optical intensity of the 0-th order light monitored by the first monitor and a predetermined reference value, and controls the first phase shifter so that the optical intensity of the 0-th order light is less than the reference value, and
compares the optical intensity of the 0-th order light monitored by the first monitor and a predetermined reference value, and controls the modulation voltage amplitude applied to the first phase modulator and the second phase modulator so that the optical intensity of the 0-th order light is less than the reference value.

6. A transceiver for transmitting light modulated based on a transmission symbol, the transceiver comprising:
a laser light source outputting laser light of a single wavelength;
a dual wavelength generator;
an optical amplifier; and
a transmitting unit, wherein
the dual wavelength generator has:
a first phase modulator to which the laser light is input;
a coupling and splitting coupler having a first input, a second input, a first output, and a second output, modulated output of the first phase modulator being connected to the first input and the first output being connected to output of a dual wave device;
an optical loop circuit having a first end and a second end, the second output of the coupling and splitting coupler being connected to the first end;
a second phase modulator to which the second end of the optical loop circuit is connected, modulated output of the second phase modulator being connected to the second input of the coupling and splitting coupler;
a ring resonator disposed on the optical loop circuit; and
a controller configured to control a resonance state of the optical loop circuit and a resonance state of the ring resonator, wherein
the optical amplifier optically amplifies light of two wavelengths output by the dual wavelength generator, and
the transmitting unit transmits the optically amplified light of the two wavelengths.

7. The transceiver according to claim 6, wherein
the transmitting unit includes a resonant optical modulator having:
a first phase modulator to which the laser light is input, the first phase modulator performing modulation based on a symbol to be transmitted;
a coupling and splitting coupler having a first input, a second input, a first output, and a second output, modulated output of the first phase modulator being connected to the first input and the first output being connected to an output of a dual wave device;
an optical loop circuit having a first end and a second end, the second output of the coupling and splitting coupler being connected to the first end;
a second phase modulator to which the second end of the optical loop circuit is connected, modulated output of the second phase modulator being connected to the second input of the coupling and splitting coupler, the second phase modulator performing modulation based on a symbol to be transmitted;
a ring resonator disposed on the optical loop circuit; and
a controller configured to control a resonance state of the optical loop circuit and a resonance state of the ring resonator.

8. The transceiver according to claim 7, further comprising:
a first phase shifter disposed on the optical loop circuit, the first phase shifter adjusting a ring phase of the optical loop circuit; and
a second phase shifter disposed on the ring resonator, the second phase shifter adjusting a ring phase of the ring resonator, wherein
the controller controls a modulation voltage amplitude for the first phase modulator and the second phase modulator and controls a phase shift amount of the first phase shifter and the second phase shifter.

9. A transceiver for transmitting light modulated based on a transmission symbol, the transceiver comprising at least:
a tunable laser light source outputting tunable laser light; and
a transmitter having:
a first phase modulator to which the tunable laser light is input, the first phase modulator performing modulation based on a symbol to be transmitted;
a coupling and splitting coupler having a first input, a second input, a first output, and a second output, modulated output of the first phase modulator being connected to the first input and the first output being connected to an output of a dual wave device;
an optical loop circuit having a first end and a second end, the second output of the coupling and splitting coupler being connected to the first end;
a second phase modulator to which the second end of the optical loop circuit is connected, modulated output of the second phase modulator being connected to the second input of the coupling and splitting coupler, the second phase modulator performing modulation based on a symbol to be transmitted;
a ring resonator disposed on the optical loop circuit; and
a controller configured to control a resonance state of the optical loop circuit and a resonance state of the ring resonator.
